(19) United States
(12) Patent Application Publication
(10) Pub. No.: US 2010/0208044 A1
(43) Pub. Date: Aug. 19, 2010

(54) Stereoscopic systems for anaglyph images

(75) Inventors: Michael G. Robinson, Boulder, CO (US); Joshua L. Greer, Beverly Hills, CA (US); Douglas J. McKnight, Boulder, CO (US); Matt D. Cowan, Bloomingdale (CA)

Correspondence Address: REALD Inc. - Patent Department, by Baker & McKenzie LLP, 2001 Ross Avenue, Suite 2300, Dallas, TX, 75201, US

(73) Assignee: REAL D, Beverly Hills, CA (US)

(21) Appl. No.: 12/709,453

(22) Filed: Feb. 19, 2010

Related U.S. Application Data
(60) Provisional application No. 61/153,949, filed on Feb. 19, 2009.

(51) Int. Cl. H04N 13/04

(52) U.S. Cl. 348/53; 348/60; 348/E13.075

(57) ABSTRACT

Encoding left and right eye stereoscopic image pairs into a color coded ‘anaglyph’ image allows for 3-D viewing through colored eyewear. The color mapping may be tailored locally to specific eyewear and display hardware and generates anaglyph output from distributed full-color left and right eye stereoscopic data. In an exemplary embodiment, determination of eyewear may involve viewer interaction through visual inspection of displayed calibration images or by other means. Left and right eye data may be mapped onto high quality anaglyph images. The overall approach attempts to provide a consistent, good quality stereoscopic experience for different displays and eyewear.

### TECHNICAL FIELD

This disclosure generally relates to stereoscopic imaging and more specifically relates to anaglyph mapping.

### BACKGROUND

The recent interest in stereoscopic 3D cinema may be attributed to the image quality achieved with the latest projection hardware. Full-color, left and right eye image sequences are projected with highly-matched chromaticity and luminosity. The audience wears sophisticated eyewear which differentiates the images for each eye with minimal cross-talk. This same quality is desired in the home. Though possible with the 3D ready TVs, the vast majority of viewers at the present time are limited to what can be displayed on conventional TVs.

### SUMMARY

This disclosure provides an anaglyph mapping processor operable to provide encoded stereoscopic anaglyph images to be viewed on a display by a viewer. The processor may comprise a first communication interface operable to receive full-color left-eye and right-eye stereoscopic images and a second communication interface operable to receive information about a stereoscopic eyewear type. The processor may further comprise a controller operable to generate encoded anaglyph images from the full-color left-eye and right-eye stereoscopic images based on the information about the stereoscopic eyewear type.

This disclosure also provides a anaglyph processing system operable to provide encoded anaglyph images to be viewed on a display by a viewer. In an embodiment, the system may comprise a stereoscopic image decoder operable to receive full-color stereoscopic image content from a content source and generating full-color left-eye and right-eye stereoscopic images. The system may also comprise an anaglyph mapping processor operable to receive information about stereoscopic eyewear type and generate encoded anaglyph images from the full-color left-eye and right-eye stereoscopic images based on the information about the stereoscopic eyewear type. The system may further comprise a communication interface operable to transmit the full-color left-eye and right-eye stereoscopic images from the stereoscopic image decoder to the anaglyph mapping processor.

The present disclosure is also directed to an method of anaglyph encoding, the method comprising receiving full-color left-eye and right-eye stereoscopic images. The method may further comprise receiving information about a stereoscopic eyewear type and generating encoded anaglyph images from the full-color left-eye and right-eye stereoscopic images based on the information about the stereoscopic eyewear type.

### BRIEF DESCRIPTION OF THE DRAWINGS

FIG. 1 is a schematic diagram illustrating anaglyph eyewear in accordance with the present disclosure;

FIG. 2 is a schematic diagram illustrating stereoscopic images to be encoded by anaglyph mapping, in accordance with the present disclosure;

FIG. 3 is a schematic diagram illustrating various anaglyph mapping of the stereoscopic images shown in FIG. 2, in accordance with the present disclosure;

FIG. 4 is a schematic diagram illustrating an embodiment of an anaglyph mapping processor, in accordance with the present disclosure;

FIG. 5 is a schematic diagram illustrating an embodiment of an anaglyph processing system, in accordance with the present disclosure;

FIG. 6 is a diagram illustrating exemplary instructions for determining the color of the stereoscopic eyewear, in accordance with the present disclosure;

FIG. 7 is a diagram illustrating further exemplary instructions for determining the color of the stereoscopic eyewear, in accordance with the present disclosure;

FIG. 8 is a diagram illustrating exemplary instructions for determining the transmission level of the primary colors, in accordance with the present disclosure;

FIG. 9 is a diagram illustrating exemplary instructions for determining the color leakages of the primary colors, in accordance with the present disclosure;

FIG. 10 is a diagram illustrating further exemplary instructions for determining the color leakages of the primary colors, in accordance with the present disclosure; and

FIG. 11 is a schematic diagram illustrating various anaglyph mapping of the stereoscopic images shown in FIG. 2.

### DETAILED DESCRIPTION

The basic principle of anaglyph imaging relies on the ability of humans to correlate a colored image in one eye with a complimentary colored stereoscopically paired image in the other. This ability may not be obvious, but is a trait common to the majority of the population. A conventional technique for providing 3D imaging to homes is to provide conventional anaglyph (color-coded stereo imagery) viewed with color filtering eyewear. Anaglyph film content such as ‘Hannah Montana’ has already been released on Blu-Ray disks with considerable commercial success.

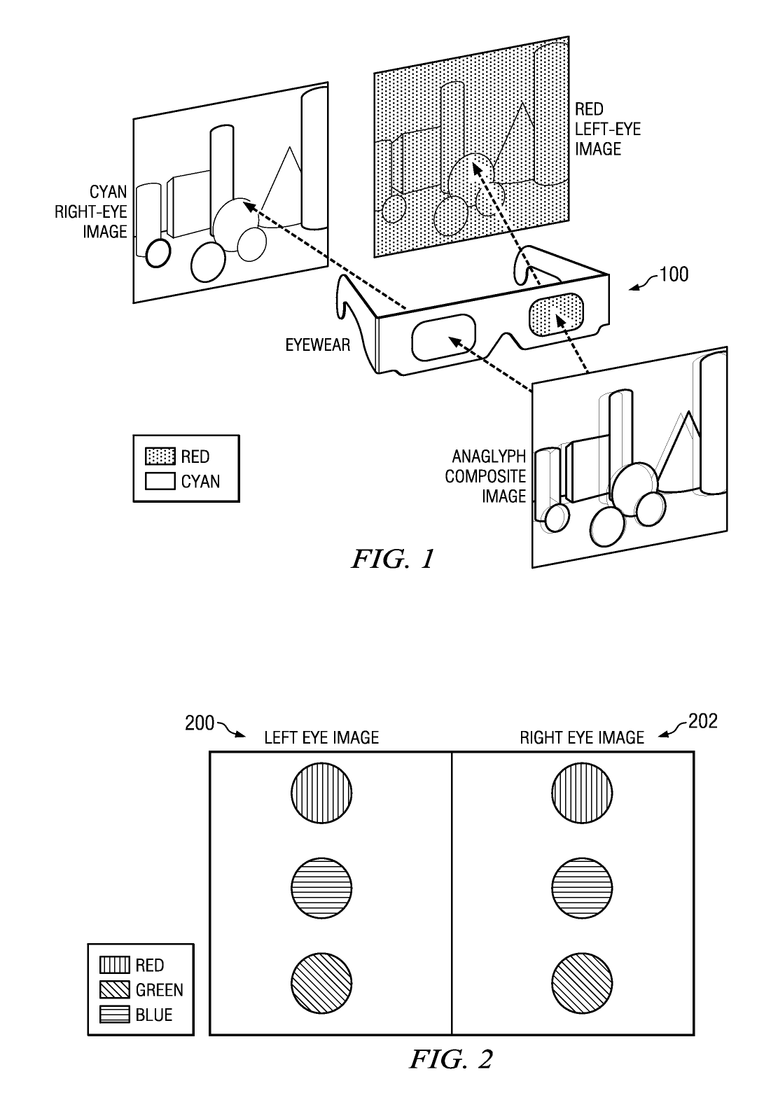

FIG. 1 is a schematic illustration of eyewear 100, which may be suitable for viewing encoded anaglyph images generated by stereoscopic imaging devices of the present disclosure. Eyewear 100 may be Red/Cyan eyewear, and as shown in FIG. 1, the right eye only sees a cyan image whereas the left sees a red image. The disparity or horizontal displacement between cyan and red object images results in stereoscopic sensation of depth. In this case, where the red (R′) and cyan (Cy′) channels are simply separated from the full-color RGB stereoscopic data, reasonable color reproduction is provided. This ‘full-color’ mapping may be described mathematically as follows:

$$( \begin{matrix}r \\ g \\ b\end{matrix} ) = ( \begin{matrix}1 & 0 & 0 \\ 0 & 0 & 0 \\ 0 & 0 & 0\end{matrix} ) \cdot ( \begin{matrix}{r}_{l} \\ {g}_{l} \\ {b}_{l}\end{matrix} ) + ( \begin{matrix}0 & 0 & 0 \\ 0 & 1 & 0 \\ 0 & 0 & 1\end{matrix} ) \cdot ( \begin{matrix}{r}_{r} \\ {g}_{r} \\ {b}_{r}\end{matrix} ) . \qquad Equation 1$$

where (r, g, b), (rᵣ, gᵣ, bᵣ) and (rₗ, gₗ, bₗ) are the pixel RGB coefficients for the anaglyph, full-color left, and full-color right eye images respectively.

A correct color sensation may be difficult with anaglyph imaging. In the red/cyan case there may be a noticeable lack of red experienced by most right eye dominant viewers. For those who are left eye dominant, unpleasant color oscillation may be experienced where objects change hue on a timescale of seconds. Also with this approach, there may be significant retinal rivalry where objects often appear to have significant brightness differences between left and right eyes. This may lead to problematic image fusion and related eyestrain, and is particularly noticeable for saturated colored objects.

An alternative is to create ‘grey’ anaglyph images. In this case, the brightness of the full-color left and right eye images are purportedly mapped onto the red and cyan channels respectively. This may ensure that intensity variations between all object images in left and right eyes, while not equal, are nevertheless a fixed ratio of each other. This removes substantially all color information, but makes the resulting image much more comfortable to view. Mathematically, the mapping is given by:

$$( \begin{matrix}r \\ g \\ b\end{matrix} ) = ( \begin{matrix}0.299 & 0.587 & 0.114 \\ 0 & 0 & 0 \\ 0 & 0 & 0\end{matrix} ) \cdot ( \begin{matrix}{r}_{l} \\ {g}_{l} \\ {b}_{l}\end{matrix} ) + ( \begin{matrix}0 & 0 & 0 \\ 0.299 & 0.587 & 0.114 \\ 0.299 & 0.587 & 0.114\end{matrix} ) \cdot ( \begin{matrix}{r}_{r} \\ {g}_{r} \\ {b}_{r}\end{matrix} ) . \qquad Equation 2$$

The matrix elements are related to the intensity distribution between red, green and blue spectral emission of Rec. 601 compliant displays and relates to older cathode ray tube (CRT) display phosphors. Both these assumptions do not strictly hold for modern liquid crystal displays (LCDs), making the precise mapping numbers somewhat over specified. Furthermore, the mapping of Equation 2 may not be a correct intensity mapping due to the non-linear gamma scaling between RGB coefficients and display intensity output. For most modern Windows® compliant displays, the luminance L of a red, green or blue pixel is very closely given by:

$$L = {L}_{max} \cdot {( \frac{pix}{255} )}^{2.2} \qquad Equation 3$$

Nonetheless, the fixed ratio of intensities between left and right eyes for all objects with this ‘grey’ anaglyph method provides comfortable depth perception. As such, it highlights the intrinsic trade-off between color sensation and image fusion for anaglyph pixel mapping techniques.

Another alternative compromise mapping is the so-called ‘half-color’ approach which maps ‘intensity’ into the color deficient single primary eye while leaving unchanged the other eye's pixel mapping coefficients. The mapping in this case may be described as:

$$( \begin{matrix}r \\ g \\ b\end{matrix} ) = ( \begin{matrix}0.299 & 0.587 & 0.114 \\ 0 & 0 & 0 \\ 0 & 0 & 0\end{matrix} ) \cdot ( \begin{matrix}{r}_{l} \\ {g}_{l} \\ {b}_{l}\end{matrix} ) + ( \begin{matrix}0 & 0 & 0 \\ 0 & 1 & 0 \\ 0 & 0 & 1\end{matrix} ) \cdot ( \begin{matrix}{r}_{r} \\ {g}_{r} \\ {b}_{r}\end{matrix} ) . \qquad Equation 4$$

When viewing anaglyph images, it appears that the overriding color sensation comes from the dual primary channel. The disparity or depth appears to be derived from sensing an object's relative location in the single primary image. This approach is known to provide more colorful anaglyph, as disclosed by Sorensen et al in U.S. Pat. No. 6,687,003, which is hereby incorporated by reference. This so-called ColorCode 3•D™ places blue in one eye and amber in the other. Amber in this case contains contributions from all three primaries including some blue which allows one eye to see color contributions across the visible at the expense of slight blue cross-talk. The blue image primarily provides depth information, but also contributes to the image's overall blue hue.

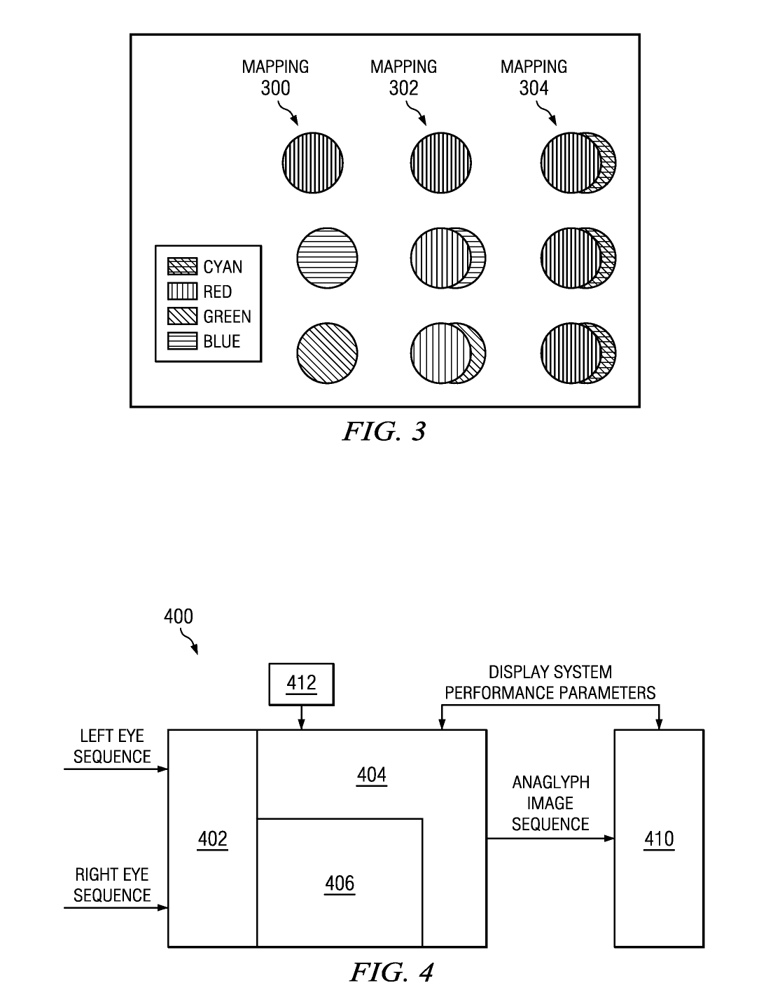

FIG. 2 is a schematic diagram of left and right dot test images 200 and 202 that may be mapped to provide anaglyph images, and FIG. 3 is a schematic diagram illustrating the mapping of test images 200 and 202 according to the above discussed approaches. Anaglyph mapping 300 is an illustration of the “full-color” mapping approach as discussed above, which preserves all color information, but may lead to retinal rivalry. Anaglyph mapping 302 is an illustration of the “half-color” mapping approach as discussed above. Anaglyph mapping 304 is an illustration of the “grey” mapping approach as discussed above.

Another recent approach to anaglyph is to provide full-color to both eyes in the form of red, green and blue non-spectrally overlapping wavelength bands, as disclosed by Jorke in U.S. Pat. No. 6,698,890, which is hereby incorporated by reference. This has been very successful deployed in cinemas by Dolby with modified projection hardware and matching dichroic filter eyewear. Though anaglyph in nature, this approach is difficult to implement with conventional three primary color TV systems. The approach may be particularly effective to optimize 3D representations in TV systems in current or future development, particularly including such systems being driven by six or more color spectra, such as displays proposed by Sharp in the commonly assigned U.S. Pat. App. No. 2007/0188711, which is hereby incorporated by reference.

The conventional red/cyan and the newer ColorCode 3•D™ anaglyph mappings add to the many different color combinations that are already promoted and readily available (see, e.g., anaglyph methods disclosed by Western in U.S. Pat. No. 6,389,236, which is hereby incorporated by reference). Within the standard approaches there are also variations in filter performances that are difficult to control and quantify. One reason is the color reproduced on different displays and individual color balance settings may vary considerably. This situation results in highly variable quality anaglyph content seen on TV displays. In some cases, when eyewear is not matched regarding the primaries, it is rendered virtually un-viewable.

As discussed above, a conventional approach for delivery stereoscopic content to households involves mastering content in a specific anaglyph form to be viewed with provided eyewear. As such, it is not tolerant of the variation in displayed color, the viewer's anaglyph preference, and the many pairs of eyewear that might be available to the viewer. Eyewear has yet to be standardized, with recent content released with markedly different color mappings. Households may include a wide variety of TV technologies. With such a variation in playback hardware, it may be desirable to provide full-color content to all households such that those with the latest display equipment can then experience high quality 3D.

Accordingly, there is a need for an approach for providing 3D content while allowing the viewers or local systems to choose between a variety of preferences. For example, eyewear with red/cyan lenses may be swapped out for those having amber/blue lenses for the most recent offerings. In accordance with the present disclosure, locally determined anaglyph presentation may be provided from the full-color stereoscopic content. Local determination may be based on viewer provided information and/or automatic or semi-automatic interrogation of the display hardware.

FIG. 4 is an exemplary embodiment of an anaglyph mapping processor 400 operable to provide locally encoded stereoscopic anaglyph images to be viewed on a display 410 by a viewer. The processor 400 may include a first communication interface 402 operable to receive full-color left-eye and right-eye stereoscopic images and a second communication interface 404 operable to receive information about a stereoscopic eyewear type. The stereoscopic eyewear type may include various parameters related to the type and nature of the eyewear, such as color, transmission, leakage, or any other metrics in the art used to measure the performance of the stereoscopic eyewear. The processor 400 may include a controller 406 operable to generate encoded anaglyph images from the full-color left-eye and right-eye stereoscopic images based on the information about the stereoscopic eyewear type.

In some embodiments, the stereoscopic eyewear type, which may include the performance parameters of the eyewear, may be determined automatically through techniques such as bar code reading, radio frequency identification, or CCD inspection, etc. For example, in an embodiment, the processor 400 may include a signal receiver 412 operable to receive signals transmitted from a signal emitter coupled to the stereoscopic eyewear (not shown), and the signals may include information about the stereoscopic eyewear type. In this embodiment, the second communication interface 404 may be configured to receive the information about the stereoscopic eyewear type from the signal receiver 412. It is to be appreciated that the signal receiver 412 may be any type of signal receiver known in the art, such as a bar code reader or a radio frequency reader.

With the non-standard eyewear variations, direct viewer feedback may be used to determine the nature of the eyewear. In an exemplary embodiment, the controller 406 may be further operable to provide instructions for the viewer to input the information about the stereoscopic eyewear type, and the second communication interface 404 may be further operable to transmit the instructions to the display 410 and return the information about the eyewear input by the viewer to the controller 406.

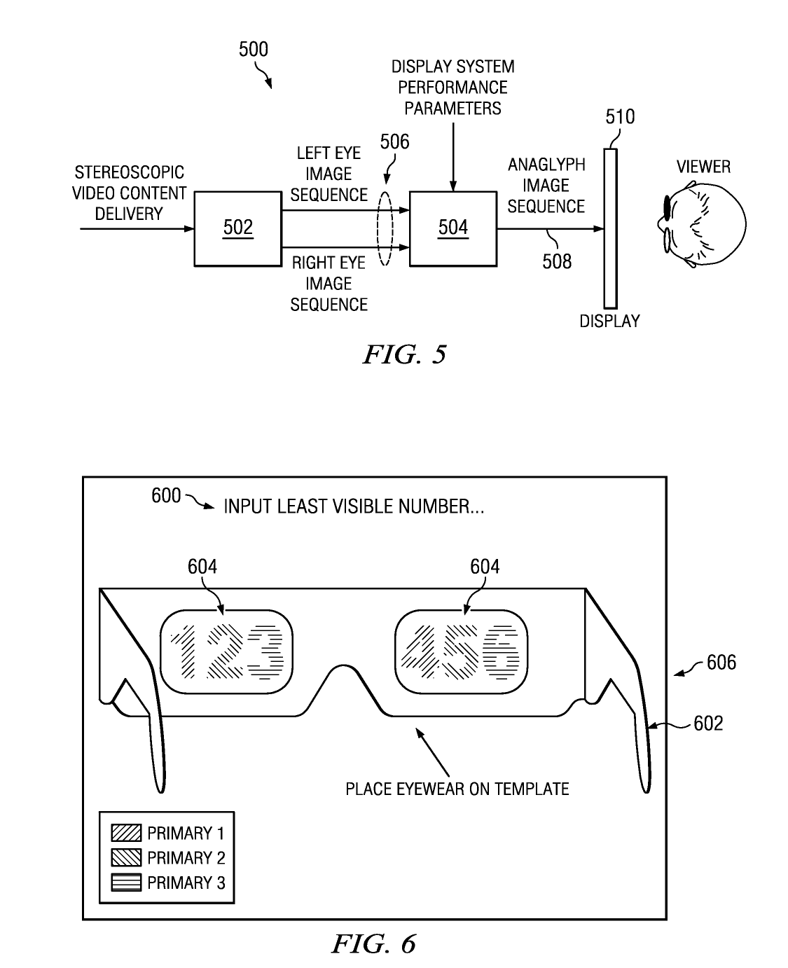

FIG. 5 is a schematic diagram illustrating an anaglyph processing system 500 operable to provide locally determined anaglyph presentation from full-color stereoscopic imaging content. In an embodiment, the anaglyph processing system 500 may include a stereoscopic image decoder 502 operable to receive full-color stereoscopic image content from a content source (not shown) and generate full-color left-eye and right-eye stereoscopic images. The anaglyph processing system 500 also may include an anaglyph mapping processor 504 operable to receive information about stereoscopic eyewear type and generate encoded anaglyph images from the full-color left-eye and right-eye stereoscopic images based on the information about the stereoscopic eyewear type. The anaglyph mapping processor 504 may be the processor 400 discussed above or any other suitable processor in accordance with the present disclosure. Moreover, the anaglyph processing system 500 may further include a communication interface 506 operable to transmit the full-color left-eye and right-eye stereoscopic images from the stereoscopic image decoder 502 to the anaglyph mapping processor 504.

In an embodiment, the anaglyph mapping processor 504 is further operable to provide instructions for the viewer to input the information about the stereoscopic eyewear type, and the anaglyph processing system 500 further comprises a second communication interface 508 operable to transmit the instructions to a display 510 and further transmit the information about the stereoscopic eyewear type input by the viewer to the anaglyph mapping processor 504.

In some embodiments, in the absence of any significant experience with stereoscopic viewing, a variety of viewer instructions may be used to provide friendly, non-technical approaches for determining stereoscopic eyewear type without relying on sophisticated measuring equipment. In an exemplary embodiment, the instructions for the viewer may include interrogation of displayed test patterns which are to be viewed through the stereoscopic eyewear. To make it simple for the viewer, easy to understand instructions may be provided with a simple input of decisive results. In some embodiments, instructions that require simple input (e.g. true/false or entering numbers) and become progressively more difficult may be used. A bail-out option (such as “don't know”) may be provided to avoid any ambiguity. Additionally, an input in response to the instruction to the viewer may be fed back to the processor 400 or 504 through the display 410 or 510, respectively. In the case of a TV, a remote control unit may be used for feedback. Depending on the test pattern, the viewer may wear the eyewear, though an alternative method may involve placing eyewear directly in front of the screen in a clearly marked position, which allows interrogation of individual lenses without the viewer to looking through the lenses.

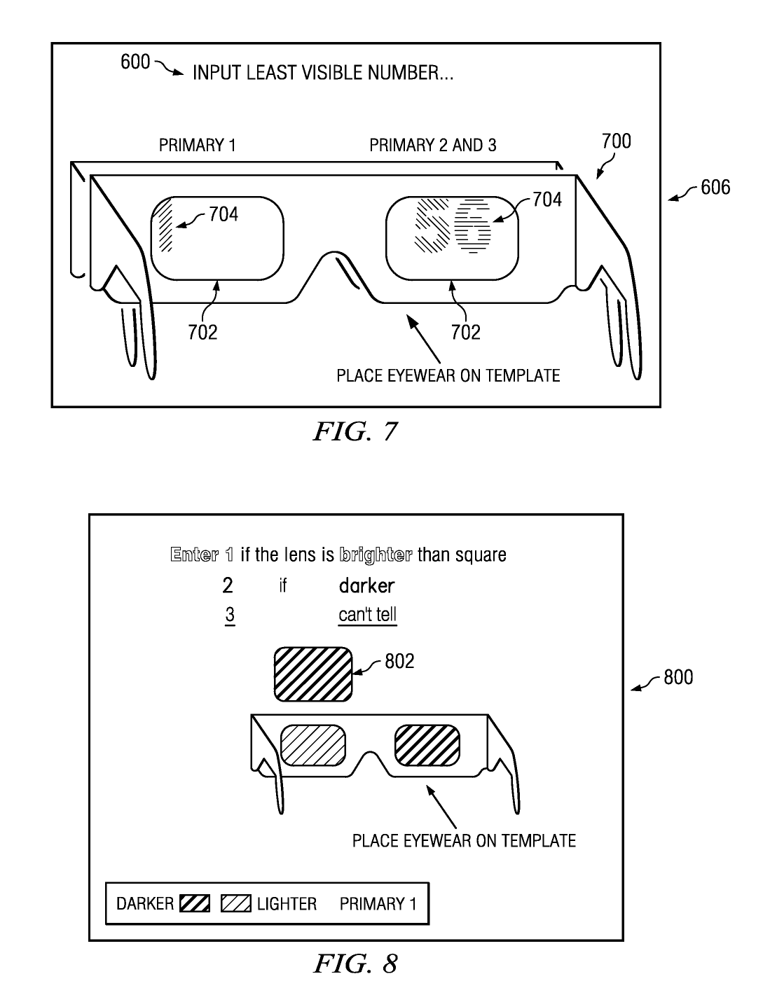

In an embodiment, the instructions for determining stereoscopic eyewear type includes instructions for determining the color of the left- and right-eye lenses of the stereoscopic eyewear. FIG. 6 illustrates exemplary instructions 600 that include displaying, on a display 606, a location template 602, against which a viewer may place the eyewear. At the lens locations are indistinct predominantly primary colored numbers 606. FIG. 7 schematically illustrates a distinct set of numbers 704 that may be observed by the viewer through filtering lenses 702 when the stereoscopic eyewear 700 is placed on the location template 602. Above the eyewear position is the instructions 600 that prompt the viewer to input the least visible numbers 704 using an input device (not such as a TV remote control. As such, based on the color that the viewer identified as least visible, the color of the lenses of the stereoscopic eyewear 700 may be determined, and such information may be used to generate encoded anaglyph images.

In an embodiment, the information on stereoscopic eyewear type desired for anaglyph mapping may include the relative intensities of the primary colors transmitted through the eyewear lenses. This may include six pieces of information: the fraction of Red light through the left lens, the fraction of Green light through the left lens, the fraction of Blue light through the left lens, the fraction of Red light through the right lens, the fraction of Green light through the right lens, and the fraction of Blue light through the right lens. The primary colors are defined in the present disclosure to be those emitted by the display. Hence this approach provides for the different spectral emissions of an LCD compared to those of a Plasma TV. The following six parameters may be derived from instructions for determining the transmission level of the left- and right-eye lenses of the stereoscopic eyewear:
(1) (T_{R})^{r}—The transmission of Red light through the lens in front of the viewers' right eye.
(2) (T_{G})^{r}—The transmission of Green light through the lens in front of the viewers' right eye.
(3) (T_{B})^{r}—The transmission of Blue light through the lens in front of the viewers' right eye.
(4) (T_{R})^{l}—The transmission of Red light through the lens in front of the viewers' left eye.
(5) (T_{G})^{l}—The transmission of Green light through the lens in front of the viewers' left eye.
(6) (T_{B})^{l}—The transmission of Blue light through the lens in front of the viewers' left eye.

Either a full or partial set of parameters allows a related anaglyph mapping to be implemented, which could be standard or more sophisticated depending on the information provided.

FIG. 8 is a schematic diagram of exemplary instructions 800 for determining the transmission level of the left- and right-eye lenses of the stereoscopic eyewear. In FIG. 8, a set of images may be displayed in sequence similar to that shown in FIGS. 6 and 7. The images form a series where the intensity of a primary colored patch 802 is altered until the viewer cannot distinguish a difference between its brightness and that lens which is illuminated by the same full primary illumination. A second and third set of images interrogating the transmission of the second and third primaries surrounding the appropriate lens are next presented. At each step, when the viewer cannot distinguish the brightness, the test proceeds to the next color. These images give indication of the relative transmission of the primary colors through the lenses.

Given the transmission levels of the primary colors, the controller 406 of the processor 400 or the processor 504 may be operable to generate encoded anaglyph images that account for a difference in the transmission level of the left-eye and right-eye lenses of the stereoscopic eyewear, such that, after the encoded anaglyph images are decoded by the stereoscopic eyewear, the viewer would perceive anaglyph images with substantially equal light intensity.

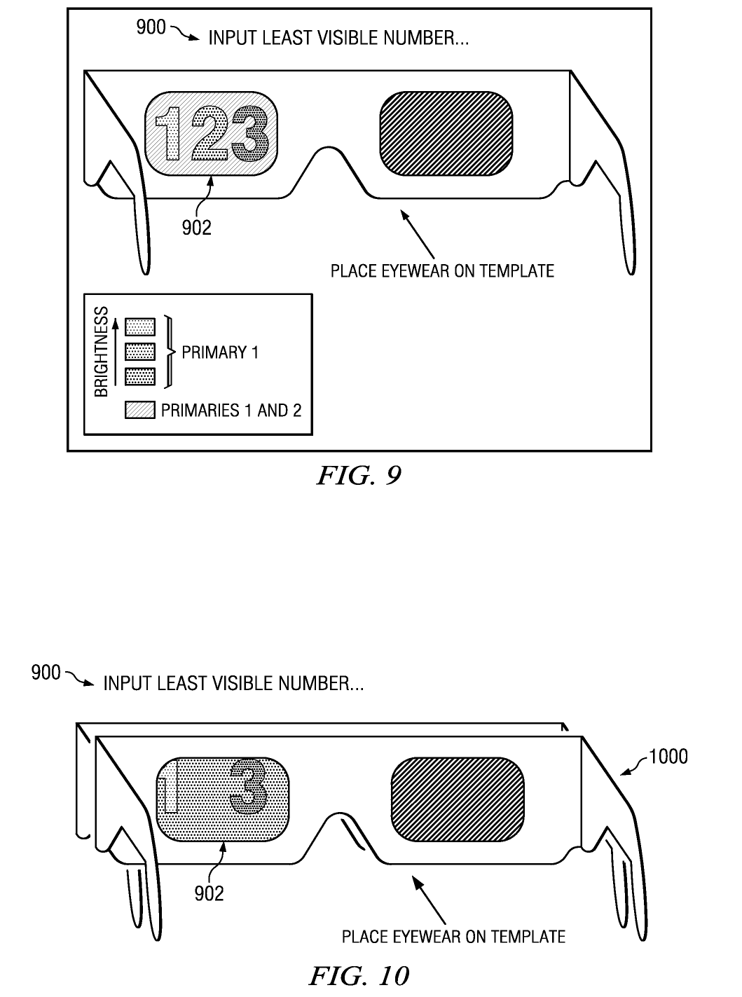

FIG. 9 is a schematic diagram of exemplary instructions 900 for determining color leakages of the left- and right-eye lenses of the stereoscopic eyewear. The instructions 900 may include providing the least visible number seen through the located eyewear for the image shown in FIG. 9. The images 902 displayed on the screen at the lens locations are similarly colored numbers of varying intensity on a uniform background. In the illustrated embodiment, the left image has a background of a first primary at a mid-intensity level (for example, 50% of its maximum) mixed with a 100% second primary intensity. The numbers are colored with the first primary only; their brightness increasing stepwise from the 50% of the background. The closest brightness match between the perceived background and a number renders it least visible and helps quantify leakage. If, for example, the least visible number corresponds to first primary intensity of 60% of its maximum, then the second primary intensity leakage is 60%-50% or 10% of the first primary's maximum brightness.

FIG. 10 illustrates an exemplary transmitted output when seeing the image 902 through eyewear 1000. Displaying a set of five further similar images with primary combinations completes the instructions 900 for determining the color leakage. Given the color leakages, the controller 406 of the processor 400 or the processor 504 may be operable to generate encoded anaglyph images that account for the color leakages of the left-eye and right-eye lenses of the stereoscopic eyewear, such that, after the encoded anaglyph images are decoded by the stereoscopic eyewear, the viewer would perceive anaglyph images with reduced color leakages.

Anaglyph mapping of different complexities may be determined depending on the obtained information of local display hardware or stereoscopic eyewear type. In the simplest case where only the basic transmission levels are provided, such as red/cyan or blue/yellow, pre-determined conventional mapping such as mappings 300, 302, and 304 as shown in FIG. 3 may be implemented. In the more sophisticated case, where more local information is provided, a more optimal mapping may be implemented. In an embodiment, one mapping may include a compromise between image fusion and color correctness by first, color-correcting through scaling of the perceived primary color intensities to a fixed fraction of that seen on the display by the naked eye. Second, it trading-off the color saturation against the retinal rivalry that occurs should object intensities differ significantly between eyes. Unlike the conventional approaches, it does this symmetrically by adding object brightness information into both eyes.

The approach (assuming red/cyan) can be described by the following mathematical relation:

$$( \begin{matrix}r \\ g \\ b\end{matrix} ) = {[ \begin{matrix}[ \begin{matrix}( 1 - κ - λ ) & κ & λ \\ 0 & 0 & 0 \\ 0 & 0 & 0\end{matrix} ] \cdot ( \begin{matrix}\frac{T}{{T}_{R}} & 0 & 0 \\ 0 & \frac{T}{{T}_{G}} & 0 \\ 0 & 0 & \frac{T}{{T}_{B}}\end{matrix} ) \cdot \\ {( \begin{matrix}{r}_{l} \\ {g}_{l} \\ {b}_{l}\end{matrix} )}^{γ} + [ \begin{matrix}0 & 0 & 0 \\ α & ( 1 - α ) & 0 \\ β & 0 & ( 1 - β )\end{matrix} ] \cdot \\ ( \begin{matrix}\frac{T}{{T}_{R}} & 0 & 0 \\ 0 & \frac{T}{{T}_{G}} & 0 \\ 0 & 0 & \frac{T}{{T}_{B}}\end{matrix} ) \cdot {( \begin{matrix}{r}_{r} \\ {g}_{r} \\ {b}_{r}\end{matrix} )}^{gamma}\end{matrix} ]}^{\frac{1}{gamma}} . \qquad Equation 5$$

where:

T_{R}=(T_{R})^{r}+(T_{R})^{l}, T_{G}=(T_{G})^{r}+(T_{G})^{l}, T_{B}=(T_{B})^{r}+(T_{B})^{l} and T=min(T_{R},T_{G},T_{B}).

The matrix containing the transmission data may constitute an upfront color calibration step. The cross-color intensity mapping parameters α,β, κ, and λ, are then associated with the mapping and may be viewer dependent. Non-zero values for α and/or μ may be used in this approach. The value for gamma may be 2.2, but might vary dependent on display settings.

For alternative to red/cyan eyewear, the equation may be transformed by associating the red and left labels to the color and location of the new single primary lens. Green and blue are then associated with the brightest and darkest colors of the second dual primary lens. A viewer might make a final mapping preference by comparing simultaneously differently mapped anaglyph images.

Information about stereoscopic eyewear type, including for example, colors, transmission levels, and/or color leakages of the stereoscopic eyewear as determined in FIGS. 6-10, may allow anaglyph images to be mapped by full-color left and right eye images. From visual inspection, an exemplary embodiment of mapping parameters relating to Equation 5 (assuming again red-cyan eyewear) may be:

(α,β,κ,λ,gamma)=(0.015±0.05,0.09±0.05,0.6±0.05,0.1±0.05,2.2)

The κ and λ values may be chosen to closely map pixel intensities (independent of color) of the left eye image onto the output red channel. The effective brightness of the now red left eye image is ˜30% of the original full-color white brightness. This mapping may be visually comfortable as it is similar to the established ‘half-color’ mapping approach, although of course in our case we work in linear intensity space. α and μ are chosen to map closely the red pixel intensities of the right eye image onto the blue and green channels in proportion to their relative intensities. α is effectively the product of the blue to red brightness ratio ˜30% and the ˜30% red to white (residual left eye to right eye) brightness ratio; hence ˜9% or 0.09, whereas) μ (˜0.015) is a further factor of ˜5 less in accordance with green to blue brightness ratio. With this mapping saturated red objects may be seen in both eyes with equal brightness allowing for some red color reproduction and good fusion. It is possible to visualize this by investigating the anaglyph reproduction of the test images of FIG. 2.

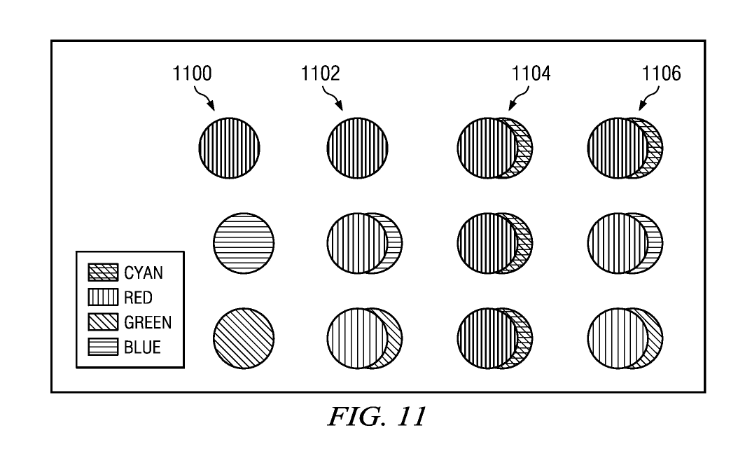

FIG. 11 is a schematic diagram showing anaglyph reproductions of dot test images of FIG. 2. The first anaglyph uses ‘full-color’ mapping 1100, the second anaglyph uses ‘half color’ mapping 1102, the third anaglyph uses ‘grey’ mapping 1104, and the last anaglyph uses (α, μ, κ, λ, gamma)=(0.015, 0.09, 0.6, 0.1, 2.2) mapping 1106. In these images, red/cyan eyewear is assumed. A viewer may notice that the ‘full-color’ image may have the ‘best’ color reproduction, but may cause the most fusion discomfort. The ‘grey’ reproduction may be easily fused but may provide virtually no color. ‘Half-color’ may provide a good compromise between color reproduction and fusion comfort for mixed color objects, but may fail for red since there is no right eye information. The anaglyph mapping 1106 shows a mapping that provides a good compromise over the visible color and intensity ranges. The mapping 1106 can easily be applied to other eyewear such as blue/yellow with appropriate manipulation in accordance with the methodology described above. Similar calibration routines may be implemented with a user-determined anaglyph mapping of a more conventional type such as ‘full-color’, ‘grey’, etc.

Calibration steps combined with alternative mappings may also be implemented. For example, alternative calibration images may be used, such as Ishihara-type colorblindness mosaic patterns. Alternative interactions with the viewer may be proposed, such as voice input. A camera facing the viewer may be provided to detect first level eyewear information though image processing. Calibration may also be simplified by removing the higher level information. The minimum required to be covered by this method is the first level where the type of eyewear is determined.

Calibration may also be predetermined. In such a case, the viewer may simply be prompted to input a code associated with eyewear, and possibly the display, for appropriate anaglyph mapping. Another implementation might offer a choice of calibrating a first time or not. If skipped, playback would default to some predetermined mapping. Warnings may be provided for viewers to activate the calibration should discomfort and/or below par viewing be experienced. Viewer choice of anaglyph mapping may then be implemented where the correct eyewear could be ascertained by looking at differently mapped stereoscopic images. In general, the viewer may control the mapping by either assessing the display hardware through calibration or through choice of ‘best’ experience.

As discussed above the anaglyph mapping may include existing methods and still fall under the calibrated anaglyph concept, as would modification of the proposed mapping. For example the transformation to intensity space may be removed for the sake of reduced computation costs. Also the content might be mapped into a distorted intensity space using a different value of gamma. This allows the color channel mixing to be affected by saturation level offering more flexibility to control the subtle color/fusion trade-off. Similarly the mapping may allow for image content. Frames containing a larger number of saturated colored pixels could, for example, be mapped with greater color channel mixing avoiding retinal rivalry. In contrast, more natural content could reduce color mixing to provide better color reproduction. On-the-fly content processing would be required or the content could contain tags encoded within the image or as digital metadata that could trigger different mappings.

Viewer input and optimal mapping may be considered separately as standalone embodiments as well as within a combined system embodiments.

It is assumed throughout that full-color left and right eye digital images are provided. This calibrated anaglyph approach therefore complements video distribution of such content such as those provided through MPEG multi-view or RealD's side-by-side formats.

It is to be appreciated that any of the above discussed mapping approach may be performed by either the controller 406 of the anaglyph mapping processor 400 or the mapping processor 504 of the anaglyph processing system 500 to generate encoded anaglyph images from full-color stereoscopic images.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. An anaglyph mapping processor operable to provide encoded stereoscopic anaglyph images to be viewed on a display by a viewer, the processor comprising:
a first communication interface operable to receive full-color left-eye and right-eye stereoscopic images;
a second communication interface operable to receive information about a stereoscopic eyewear type;
a controller operable to generate encoded anaglyph images from the full-color left-eye and right-eye stereoscopic images based on the information about the stereoscopic eyewear type.

2. The anaglyph mapping processor of claim 1, wherein the controller is further operable to provide instructions for the viewer to input the information about the stereoscopic eyewear type.

3. The anaglyph mapping processor of claim 2, wherein the second communication interface is further operable to transmit the instructions to the display and further transmit the information about the stereoscopic eyewear type input by the viewer to the controller.

4. The anaglyph mapping processor of claim 2, wherein the instructions comprise instructions for determining the color of the left- and right-eye lenses of the stereoscopic eyewear.

5. The anaglyph mapping processor of claim 2, wherein the instructions comprise instructions for determining the transmission level of the left- and right-eye lenses of the stereoscopic eyewear.

6. The anaglyph mapping processor of claim 5, wherein the controller is operable to generate encoded anaglyph images that account for a difference in the transmission level of the left-eye and right-eye lenses of the stereoscopic eyewear, such that, after the encoded anaglyph images are decoded by the stereoscopic eyewear, the viewer would perceive anaglyph images with substantially equal light intensity.

7. The anaglyph mapping processor of claim 2, wherein the instructions comprise instructions for determining color leakages of the left- and right-eye lenses of the stereoscopic eyewear.

8. The anaglyph mapping processor of claim 7, wherein the controller is operable to generate encoded anaglyph images that account for the color leakages of the left-eye and right-eye lenses of the stereoscopic eyewear, such that, after the encoded anaglyph images are decoded by the stereoscopic eyewear, the viewer would perceive anaglyph images with reduced color leakages.

9. The anaglyph mapping processor of claim 1, further comprising a signal receiver operable to receive signals transmitted from a signal emitter coupled to the stereoscopic eyewear, the signals including information about the stereoscopic eyewear type, wherein the second communication interface is operable to receive the information about the stereoscopic eyewear type from the signal receiver.

10. The anaglyph mapping processor of claim 9, wherein the signal receiver is a bar code reader.

11. The anaglyph mapping processor of claim 9, wherein the signal receiver is a radio frequency receiver.

12. A anaglyph processing system operable to provide encoded anaglyph images to be viewed on a display by a viewer, the system comprising:
a stereoscopic image decoder operable to receive full-color stereoscopic image content from a content source and generating full-color left-eye and right-eye stereoscopic images;
an anaglyph mapping processor operable to receive information about stereoscopic eyewear type and generate encoded anaglyph images from the full-color left-eye and right-eye stereoscopic images based on the information about the stereoscopic eyewear type;
a communication interface operable to transmit the full-color left-eye and right-eye stereoscopic images from the stereoscopic image decoder to the anaglyph mapping processor.

13. The anaglyph processing system of claim 12, wherein the anaglyph mapping processor is further operable to provide instructions for the viewer to input the information about the stereoscopic eyewear type, and the anaglyph processing system further comprises a second communication interface operable to transmit the instructions to the display and further transmit the information about the stereoscopic eyewear type input by the viewer to the anaglyph mapping processor.

14. The anaglyph mapping processor of claim 13, wherein the instructions comprise instructions for determining the color of the left- and right-eye lenses of the stereoscopic eyewear.

15. The anaglyph mapping processor of claim 13, wherein the instructions comprise instructions for determining the transmission level of the left- and right-eye lenses of the eyewear used by the viewer.

16. The anaglyph mapping processor of claim 15, wherein the anaglyph mapping processor is operable to generate encoded anaglyph images that account for a difference in the transmission level of the left-eye and right-eye lenses of the stereoscopic eyewear, such that, after the encoded anaglyph images are decoded by the stereoscopic eyewear, the viewer would perceive anaglyph images with substantially equal light intensity.

17. The anaglyph mapping processor of claim 13, wherein the instructions comprise instructions for determining color leakages of the left- and right-eye lenses of the stereoscopic eyewear.

18. The anaglyph mapping processor of claim 17, wherein the anaglyph mapping processor is operable to generate encoded anaglyph images that account for the color leakages of the left-eye and right-eye lenses of the eyewear used by the viewer, such that, after the encoded anaglyph images are decoded by the eyewear, the viewer would perceive anaglyph images with reduced color leakages.

19. An method of anaglyph encoding, the method comprising:
receiving full-color left-eye and right-eye stereoscopic images;
receiving information about a stereoscopic eyewear type;
generating encoded anaglyph images from the full-color left-eye and right-eye stereoscopic images based on the information about the stereoscopic eyewear type.

20. The method of claim 19, further comprising:
provide instructions for the viewer to input the information about the eyewear used by the viewer;
transmitting the instructions to the display;
receiving the information about the eyewear input by the viewer.

21. The anaglyph mapping processor of claim 20, wherein the instructions comprise instructions for determining the color of the left- and right-eye lenses of the stereoscopic eyewear.

22. The anaglyph mapping processor of claim 20, wherein the instructions comprise instructions for determining the transmission level of the left- and right-eye lenses of the stereoscopic eyewear.

23. The anaglyph mapping processor of claim 20, wherein the instructions comprises instructions for determining color leakages of the left- and right-eye lenses of the stereoscopic eyewear.
